(19) United States
(12) Patent Application Publication
(10) Pub. No.: US 2026/0316853 A1
(43) Pub. Date: Oct. 15, 2026

(54) VEHICLE COMBINATION COMPRISING TOWING VEHICLE AND TRAILER FOR TRANSPORTING CARGO

(71) Applicant: 4AM ROBOTICS GMBH, Leinfelden-Echterdingen (DE)

(72) Inventors: Tim Fröhlich, Leinfelden-Echterdingen (DE); Vitus Brenner, Darmstadt (DE)

(73) Assignee: 4AM ROBOTICS GMBH, Leinfelden-Echterdingen (DE)

(21) Appl. No.: 19/120,137

(22) PCT Filed: Oct. 10, 2023
(86) PCT No.: PCT/EP2023/077990

§ 371 Date: Apr. 10, 2025

(30) Foreign Application Priority Data
Oct. 11, 2022 (EP) 22200874.0

(51) Int. Cl. B62D 53/04; B25J 11/00; B60B 19/00; B62D 63/02

(52) U.S. Cl. CPC B62D 53/04; B60B 19/003; B62D 63/02; B25J 11/00

(57) ABSTRACT

The invention relates to a vehicle combination which has a towing vehicle and a trailer, wherein the towing vehicle has a coupling housing which forms a cavity, and the trailer has a coupling member, wherein the coupling housing can assume an open and a closed state, and wherein the coupling housing forms a stop surface, which stop surface extends at least in sections along an arc line, and in a section normal to the arc line delimits the cavity in a horizontal direction away from the towing vehicle, and which arc line is concavely curved with respect to a vertical axis of the towing vehicle and extends over at least half a circulation around the vertical axis of the towing vehicle, and in which cavity the coupling member can be arranged or is arranged.

The present invention relates to a vehicle combination for transporting cargo. In this case, the vehicle combination has a towing vehicle and a trailer which can be coupled to the towing vehicle with the aid of a coupling.

Robot systems which can be coupled to trailers and therefore, for example, can transport loads or carry out functional tasks (for example the cleaning of a floor) are already known.

The present invention is based on the object of specifying a vehicle combination in which the coupling between the trailer and the towing vehicle is configured in a particularly advantageous manner.

According to the invention, this object is achieved by a vehicle combination according to claim 1. The towing vehicle thereof has a coupling housing which forms a cavity and a stop surface. This stop surface extends at least in sections along an arc line which, with respect to a vertical axis of the towing vehicle, is concavely curved and extends over at least half a circulation around the vertical axis of the towing vehicle. As viewed in a section normal to the arc line, the stop surface at least partially delimits the cavity in a horizontal direction away from the towing vehicle. The stop surface thus serves as a stop for a coupled coupling member of the trailer.

This vehicle combination, in particular the extent of the stop surface along the arc line by at least half a circulation around the vertical axis, can enable distinct relative mobility between towing vehicle and coupled trailer, for instance a rotational movement of the towing vehicle relative to the trailer about its own axis (the vertical axis of the towing vehicle). As a result, it can be possible, for example, to change the position and orientation of the trailer, while at the same time requiring little maneuvering space. In particular, the vehicle combination can thereby maneuver even in narrow storage lanes (such as, for example, between high-bay shelves) or even around narrow curves.

Preferred embodiments can be found in the dependent claims and the entire disclosure, wherein, in the presentation of the features, a distinction is not always made in detail between apparatus aspects and method aspects or use aspects; in any case, the disclosure is to be read implicitly with regard to all claim categories. If, for example, the advantages of the vehicle combination or of the coupling are described in a specific application, this is to be understood at the same time as a disclosure of a corresponding use.

The coupling housing is the towing-vehicle-side part of the coupling and can be interpreted as its female part. It can assume an open state and a closed state. The open state is that state in which the coupling housing must be located in order to be able to insert the coupling member into the coupling housing and therefore to be able to couple the trailer to the towing vehicle. The closed state of the coupling housing is that state in which the coupling housing must be located with the coupling member inserted, in order that the towing vehicle can transmit driving forces to the trailer via the coupling.

The arc line extends at least over half a circulation around the vertical axis of the towing vehicle. It preferably extends around a three-quarter circulation, particularly preferably it completely surrounds the vertical axis of the towing vehicle, i.e. it forms a closed curve. Its curvature is designed such that the pivot point of the coupling is not located within the coupling housing, but within the towing vehicle. The pivot point is preferably located on the vertical axis of the towing vehicle.

As viewed in a section normal to the arc line, the cavity is preferably also at least partially delimited, particularly preferably completely delimited, towards the interior of the towing vehicle (i.e. towards the vertical axis) by the coupling housing. Furthermore, it is preferably also at least partially delimited, preferably completely delimited, in the vertical direction downwards and/or upwards by inner surfaces of the coupling housing. In any case in the closed state of the coupling housing, the cavity is also partially delimited towards the fourth side, horizontally away from the vertical axis, by the stop surface. This cross-sectional profile is present in a plurality of sections along the arc line, preferably in each section normal to the arc line.

In general, the stop surface does not necessarily have to be formed in a continuous manner along the arc line, but a segmentation is also possible, for example, with interruptions therebetween. In spite of possible interruptions, it is preferably provided in the closed state in such a manner that the coupling member bears against each rotational position (for example is large in relation to the interruptions and bridges the latter). Nevertheless, a stop surface which is continuous in the closed state without interruption, in particular closed in itself circumferentially, is preferred.

The coupling housing is in this case a fixed component of the towing vehicle. It therefore remains on the towing vehicle, irrespective of whether a trailer is coupled to the towing vehicle or not. The coupling member is the male part of the coupling and in this case a fixed component of the trailer, and therefore also remains on the trailer in the uncoupled state. Only as a result of the coupling of the towing vehicle and trailer do the coupling housing and the coupling member come into contact with one another in a form-fitting manner. The coupling serves, for example, to achieve a functional separation of the vehicle combination into the towing vehicle, for the locomotion of the vehicle combination, and the trailer, for the transport of cargo. Therefore, the towing vehicle can, for example, be coupled to different trailers and therefore the respective vehicle combination can, for example, carry out different tasks, and empty or loaded trailers can likewise be temporarily parked, e.g., for logistical reasons.

The towing vehicle has an active drive unit, and is therefore able to influence its own position, orientation and speed, for example, with integrated actuators. It can, for example, have a motor unit and a battery unit. The trailer is moved passively, for which purpose driving forces of the towing vehicle are transmitted to the trailer via the coupling; the trailer preferably does not have its own drive unit.

The vertical direction means that direction which is oriented perpendicularly to the surface of the ground. The vertical direction preferably coincides with the direction which is oriented away from the center of the earth. The horizontal direction means that direction which is oriented parallel to the surface of the ground. It is preferably oriented perpendicularly to the direction pointing away from the center of the earth. The vertical axis is the axis which is oriented in the vertical direction and is arranged within the towing vehicle. It preferably runs through the center of the towing vehicle. It particularly preferably represents an axis of symmetry of the arc line and/or an axis of rotation of the towing vehicle.

According to a preferred embodiment, the arc line, along which the stop surface extends, is closed circumferentially around the vertical axis. In general, it can be shaped, for example, in the form of an ellipse or another closed curve, but it preferably forms a circle. As a result, the towing vehicle can rotate completely about its vertical axis relative to the coupled trailer. This can be advantageous, for example, to the effect that, after the coupling, the towing vehicle can first of all rotate in a desired direction of travel before a horizontal movement of the trailer is initiated.

The stop surface is preferably formed, at least in the closed state of the coupling housing, rotationally symmetrical with respect to the vertical axis of the towing vehicle, in particular fully rotationally symmetrical. The stop surface is thus formed to a certain extent as an inner lateral surface of a hollow cylinder, the cylinder axis of which coincides with the vertical axis. In this case, the full rotational symmetry does not have to exist with a strictly mathematical accuracy. For the function, it can be sufficient, for example, if the stop surface is located in each horizontal section through the stop surface between two concentric circles lying in this section plane at a distance of 2 cm, 1.5 cm, 1 cm or 0.5 cm. The symmetry advantageously enables a rotation of the towing vehicle, while the position of the coupled trailer remains unchanged. The towing vehicle can rotate the trailer to a certain extent “on the spot”.

In the open state of the coupling housing, a part of the coupling housing is preferably offset vertically relative to the remaining coupling housing. In principle, a superposition with a horizontal offset is conceivable in this case, but an exclusively vertical offset is preferred. A coupling which opens in the vertical direction can be implemented, for example, in a space-saving manner between the towing vehicle and trailer. In addition, in the case of a vertically open coupling housing, the coupling member can be introduced into the coupling housing in a particularly simple and friction-free manner. In principle, the offset can also take place upwardly, but an downward offset is preferred.

In a preferred configuration, in the open state, a part of the coupling housing is offset vertically downwards relative to the remaining coupling housing to such an extent that a section, which is formed in the vertically offset part of the coupling housing, of a contact surface is arranged below a tread surface of the non-coupled coupling member. In this case, the contact surface is an inner surface of the coupling housing which faces the cavity and delimits the latter downwards at least in the closed state. It can be a support for the coupled coupling member. It is preferably configured in the form of an annular surface. The tread surface of the coupling member is that outer surface of the coupling member with which a coupled coupling member rests.

In the closed state of the coupling housing, the part of the coupling housing which is offset downwards in the open state is offset upwards to a common height with the remainder of the coupling housing, that is to say a continuous contact surface is formed. In this way, the coupled coupling member is likewise raised, that is to say offset upwards. As a result, on the one hand, trailers with coupling members which are located at slightly different vertical heights, for example on account of a slightly uneven ground, can advantageously also be coupled. On the other hand, as a result of the vertical movement of the coupling member during coupling, a possibly present immobilizer of the trailer can be released without additional actuators or operator actions being necessary for this purpose.

In a preferred embodiment, the contact surface is of raised design. As viewed in a section normal to the arc line, the contact surface is therefore inclined transversely towards the curve interior of the arc line. To put it graphically, the contact surface is an annular surface which slopes downwards towards its center. As a result, a contact force of the coupling member which is transmitted between the tread surface and the contact surface can be divided vectorially into a vertical and a horizontal component. The horizontal component can support the stop surface during the fixing of the coupling member. In addition, as a result of the transverse inclination, the coupling member can exhibit the tendency to assume a desired position within the coupling housing. It is thus possible, for example, to reduce a disadvantageous play and an abutment of the coupling member against the stop surface.

In a preferred embodiment, the coupling housing has a guide surface which constitutes a further inner surface of the coupling housing and delimits at least one region of the cavity vertically downwards. In a section normal to the arc line, it is located on a side of the cavity lying horizontally opposite the stop surface. The guide surface is preferably inclined transversely downwards away from the vertical axis, and therefore represents, for example, the counterpart to the contact surface. Analogously to the contact surface, the guide surface can contribute to assuming a desired position of the coupling member, for which reason reference is made to the description above.

In a preferred embodiment, the coupling member has a wheel. A substantially cylindrical lateral surface of the wheel, over which the wheel rolls, for example, on a ground during rolling, forms the tread surface. In the coupled state, the wheel is in contact with the contact surface via the tread surface. A coupling member with a wheel is particularly well suited for a relatively movement between the coupling member and the coupling housing that is as force-free as possible. As a result, the towing vehicle itself with the coupled trailer can rotate relative to the trailer as force-free as possible. The term “wheel” is intended here also to include a roller. In general, however, a ball or a sliding support could also be used instead of a wheel.

In a preferred embodiment, the vehicle combination has a further coupling member with a further wheel which, in the coupled state, is likewise arranged within the coupling housing and lies on the contact surface. The trailer could also be equipped with three or more coupling members, but preferably has precisely two coupling members. As a result, a torque can also be transmitted via the coupling members, with the result that, for example, tilting or overturning of the trailer can be prevented.

In this case, the axes of rotation of the wheels of the coupling members preferably intersect at one point with the axis of rotation of the stop surface. In other words, the coupling members of the trailer form an instantaneous center of rotation which coincides with the instantaneous center of rotation of the towing vehicle. As a result, for example, the possibility is created that the towing vehicle can also rotate about its own axis in the case of a plurality of coupling members without the trailer moving substantially forwards or rearwards in the process. This increases the maneuverability while at the same time supporting the trailer on the towing vehicle in a stable and reliable manner.

In a preferred embodiment, the towing vehicle has a wheel arrangement and/or wheel control which is configured such that the towing vehicle can rotate without horizontal offset, preferably about the vertical axis. As a result, the towing vehicle is designed to be particularly maneuverable and can move to a desired position while requiring minimum maneuvering.

The towing vehicle is preferably designed to be substantially fully rotationally symmetrical. For example, a substantially cylindrical outer contour is conceivable. As a result, the towing vehicle can be of space-saving design and, for example, the risk of a collision with cargo or other obstacles located on the trailer is reduced.

In a preferred embodiment, the trailer has at least one stand which, when the trailer is uncoupled, can enable the trailer to be placed in a frictionally engaged manner. In this case, the trailer could be equipped with only precisely one or a plurality of stands, but there are preferably two stands. As a result, an uncoupled trailer is secured, for example, against unintentional rolling away.

In a preferred embodiment, the towing vehicle is designed as an autonomous robot. This means that its driving movements and/or the coupling to the trailer can take place autonomously. The towing vehicle is therefore able to orient itself independently, for example, to move to a placed trailer, to couple the latter, to move independently with the coupled trailer, to place the trailer independently again at a desired location and to move away from the trailer.

In this way, the vehicle combination can be operated not only with little personnel expenditure, but a plurality of vehicle combinations can also be used at the same time, which can enable flexible storage logistics. In addition, a vehicle combination with an autonomous robot can have significantly smaller dimensions than a vehicle combination with a manned towing vehicle. A store operated therewith can therefore be tailored specifically to the dimensions which are required for the cargo.

In a preferred embodiment, the towing vehicle is equipped with a robot arm which is designed to load cargo onto the trailer and/or to unload said cargo. Such a robot arm can be attached, for example, centrally on the upper side of the towing vehicle. For the movement of the cargo, a mechanical gripper, a magnet or a pallet fork can be fastened, for example, to that end of the robot arm which is distal from the fastening to the towing vehicle. Advantageously, the same robot can thereby take over both the loading of the cargo and the transport thereof. Alternatively or additionally, an operator can load the trailer, for example while the towing vehicle is carrying out a driving process, e.g., with a further coupled trailer.

Preferably, the vehicle combination is used for the purpose of coupling the trailer to the towing vehicle. Firstly, a part of the coupling housing is offset vertically downwards relative to the remainder of the coupling housing, specifically to such an extent that the contact surface of the offset part of the coupling housing is arranged below the tread surface of the coupling member. Then, the coupling member is arranged within the coupling housing. This can take place as a result of a horizontal movement of the towing vehicle towards the trailer or as a result of manual insertion of the coupling member into the coupling housing, for example by an operator. Finally, the offset part of the coupling housing can be offset back upwards, that is to say the coupling housing can be transferred from the open state into the closed state. In this case, the coupling member of the trailer is raised. In this case, the stand of the trailer is also raised from the floor and therefore the frictionally engaged connection of the trailer to the floor is released. The vehicle combination is now ready for driving.

The present application furthermore relates to a drive system for a vehicle, in particular for an autonomously moving industrial truck. The vehicle described below can be used, for example, as a towing vehicle of a vehicle combination described above, but can also be used irrespective of the coupling capability of a trailer, for example can be loaded directly with a load and/or can carry a robot arm, for example for loading another vehicle, trailer or vehicle combination.

Industrial trucks are also used, for example, in bay stores with storage lanes which are not optimized specifically for, in particular, autonomously moving industrial trucks. Such storage lanes can have, for example, a small working width of less than 1 m, wherein the shelves to be serviced can have a working height of greater than 2 m. In corresponding bay stores, the use of autonomously moving industrial trucks with previously known drive systems can be challenging owing to the small working width and relatively large working height.

The present invention is based on the technical object of specifying an advantageous drive system for a vehicle.

According to the invention, this object is achieved by a drive system according to the following aspect 1. The drive system thereof comprises a first drive wheel assembly, and a first, second and third support wheel assembly. As explained in detail below, these support wheel assemblies are distributed in a particular manner over the base area of the drive system, also referred to below as “drive system surface”, and are additionally equipped in each case with at least one omni wheel. Stable support can generally be achieved by corresponding positioning of the support wheel assemblies, and the stability of the vehicle can also be maintained, for example, in the event of a change of direction by the use of omni wheels. In contrast to a trailing wheel, the omni wheel has less or no trailing offset, for example, and its support point can remain substantially constant in the event of a change of direction.

Preferred embodiments can be found in the dependent claims and the entire disclosure, wherein, in the presentation of the features, a distinction is not always made in detail between apparatus aspects and method aspects or use aspects; in any case, the disclosure is to be read implicitly with regard to all claim categories. If, for example, the advantages of the drive system are described in a specific application, this is to be seen at the same time as a disclosure of a corresponding use. The terms “a” and “an” are to be read within the scope of this disclosure, without expressly stating the opposite, as an indefinite article and therefore always also as “at least one”.

By definition, the drive system surface is spanned by a drive wheel rotation axis of the first drive wheel, that is to say the axis of rotation of the first drive wheel, and a “drive system longitudinal axis”. The latter lies perpendicularly to the drive wheel rotation axis and preferably parallel to a main movement direction of the vehicle, that is to say the preferred movement direction (“forward movement”) of the drive system or of the vehicle equipped therewith. The drive wheel is preferably of fixed design, that is to say the drive wheel rotation axis is fixed relative to the drive system longitudinal axis, in particular at right angles thereto. The “drive system surface”, that is to say the base area of the drive system, results in detail as an orthogonal projection of the drive system into a plane spanned by the drive system longitudinal axis and the drive wheel rotation axis of the first drive wheel. The drive system surface is divided by the drive wheel rotation axis into a first and a second region, that is to say, to put it graphically, into a front and a rear region.

In this case, the first support wheel assembly is arranged in the first region of the drive system surface, but the second and the third support wheel assembly are arranged in the second region. For illustration, with respect to the main movement direction, the first support wheel assembly can therefore be arranged, for example, in front of the drive wheel rotation axis, whereas the second and third support wheel assembly are arranged behind it. In the overall view, a load applied by the weight of the vehicle and/or the weight of a loading of the vehicle can be carried or distributed, for example, with the correspondingly distributed support wheel assemblies. Conversely, this example also illustrates that the distribution of the support wheel assemblies/equipment with omni wheels does indeed offer advantages, but is not mandatory in particular for a vehicle of a vehicle combination with a trailer (in general, conventional trailing wheels can also be used here, for example).

Owing to the distribution of the support wheel assemblies (with omni wheels) and therefore support points, a stable arrangement can also be achieved, for example, in the case of a base area which is small in adaptation to small working widths, and can prevent tilting, for example, despite certain working heights or even in the case of rapid acceleration and/or deceleration. Owing to the omni wheels, it is also possible in this case to maneuver on the small working width or to travel around narrow curves, that is to say, in other words, the stability exists not only with respect to the main movement direction.

In general, an omni wheel has, for example, an outer circumference with a main diameter and a main rotation axis, wherein the main rotation axis is preferably oriented orthogonally to the drive system longitudinal axis in the present case (which preferably applies to all omni wheels of the drive system). In addition, the omni wheel comprises a plurality of rollers which are arranged on the outer circumference of the omni wheel. These rollers each have a rotation axis, wherein these rotation axes, which are arranged orthogonally to the main rotation axis of the omni wheel, lie tangentially to the outer circumference, for example. Such an omni wheel is also referred to as an “omnilateral wheel” or “mecanuum wheel”, for example.

As a result of the preferably orthogonal arrangement of the main rotation axis of the omni wheel relative to the drive system longitudinal axis, an obstacle, for example a height offset or soiling on the road surface, can be crossed more easily in the main movement direction (since the main diameter of the omni wheel is greater than an individual diameter of the individual rollers). In the case of such an arrangement, the individual rollers of the omni wheel are used or required primarily for steering movements/cornering of the vehicle, but generally not for driving over obstacles. This arrangement can also reduce, for example, the wear on the individual rollers of the omni wheel.

The first drive wheel drives the drive system. For this purpose, the first drive wheel is connected to a drive, preferably an electric motor. In this case, the drive wheel can generally be coupled to the drive or electric motor, for example directly or via gearwheels or a chain or in particular via a belt drive. This can enable, for example, a weight-saving drive wheel assembly designed with little installation space; for example, the driven mass can be reduced (for example increased battery-operated service life). Furthermore, such a drive wheel assembly can also be produced, for example, in a cost-optimized manner or be less maintenance-intensive.

In general, the support wheel assemblies each have a support point, that is to say the first support wheel assembly has a first support point, the second support wheel assembly has a second support point and the third support wheel assembly has a third support point. In this case, the respective support point corresponds in each case to the point at or at which a load applied to the drive system itself or carried by the latter is transmitted to the respective support wheel assembly. Accordingly, the support point is that point at which the weight of the drive system or of the vehicle is transmitted to the respective support wheel assembly. In other words, the support point can also be considered as the point of action of a supporting action of the respective support wheel assembly with respect to the drive system.

The first support point (of the first support wheel assembly), the second support point (second support wheel assembly) and the third support point (third support wheel assembly) are arranged, for example, on a polygonal course. This polygonal course, which results to a certain extent from a union of connecting sections between the first, second and third support points, defines a support polygon of the drive system surface. Accordingly, the support polygon is an area comprised or enclosed by the polygonal course, wherein said area preferably makes up at least 30% of the drive system surface, in particular at least 40% or at least 50% (possible upper limits can be, for example, 99% or 95%).

Tilting of the vehicle can be prevented, for example, owing to a larger support polygon, even in the case of relatively large working heights or strong acceleration/deceleration. Furthermore, it is possible, owing to the distribution of the load applied to the support wheel assemblies by the weight of the vehicle and/or the load applied to the drive system by the weight of the loading, to transmit the load effectively to the road surface, or a load applied to the first drive wheel assembly can be reduced, with the result that said load can in turn be designed in a weight-/installation space-optimized manner.

As explained in detail below, the drive system preferably has a plurality of drive wheel assemblies with in each case one drive wheel, in particular two drive wheel assemblies. If a polygonal course is then formed taking into account all the support points, that is to say that of the support wheel assemblies and additionally that of the drive wheel assemblies, said polygonal course can enclose, for example, at least 70%, 80% or 85% of the drive system surface (with possible upper limits at, for example, 99% or 95%). In other words, the drive wheel assemblies and support wheel assemblies can be distributed jointly along the outer circumference of the drive system surface in such a manner that said drive wheel assembly and support wheel assembly are largely approximated by the polygonal course.

The second support point (second support wheel assembly) is spaced apart from the drive system longitudinal axis by a second angular amount, for example. Said second angular amount is measured, for example, as the smallest angle about a drive system vertical axis which is perpendicular to the drive system surface (at the point of intersection of the drive wheel rotation axis and the drive system longitudinal axis). Furthermore, the third support point (third support wheel assembly) is spaced apart from the drive system longitudinal axis by a third angular amount which is likewise measured as the smallest angle about the drive system vertical axis. The second angular amount and the third angular amount preferably differ from one another by at most 20%, particularly preferably by at most 10%. Alternatively or in combination therewith, a sum of the second and third angular amounts is preferably at least 20°, preferably at least 30°, wherein advantageous upper limits can be 120° or 90°. A corresponding arrangement of the support points can again be advantageous, for example, with regard to the stability.

In a preferred configuration, the first support point of the first support wheel assembly lies substantially on the drive system longitudinal axis, for example offset with respect to the drive system vertical axis by the amount of not more than 10° or 5° with respect to the drive system longitudinal axis. Preferably, the first support point actually lies on the drive system longitudinal axis.

In a preferred configuration, the support points lie on a substantially identical radius, again with respect to the drive system vertical axis. The support points can lie, for example, radially between or on two coaxial cylinder lateral surfaces about the drive system vertical axis, the larger of which has a diameter which is at most 10%, in particular at most 5%, larger than the smaller. This can in turn provide stability or permit a substantially round configuration of the drive system. The drive system surface thereof can then be substantially round, in particular circular, with the result that, for example, the vehicle can be maneuvered flexibly even with a small working width. In particular, it can be possible by means of a substantially round configuration of the drive system to rotate the vehicle on a spot.

In a preferred configuration, the first drive wheel assembly comprises a first pressing device. Said pressing device presses the first drive wheel at an angle, in particular perpendicularly, from the drive system surface onto the road surface, that is to say downwards with respect to the orientation during operation. The pressing device can therefore promote, for example, a uniform contact between the drive wheel and the road surface. This can prevent, for example, slipping of the drive wheel or support a sufficient application of the drive and/or braking power and therefore increase, for example, the efficiency or reliability of the drive system.

In a preferred configuration, the first pressing device comprises a spring device and/or a damper device. The spring device has, for example, a spring and is configured to decouple vibrations occurring at the drive wheel. The damper device comprises, for example, a damper, for instance oil damper, and can be configured to rapidly dissipate vibrations close to a natural frequency of the vehicle. As a result of the spring device and/or the damper device, it is possible, for example, to produce a uniform or more uniform contact with the road surface.

In a preferred configuration, the drive system furthermore comprises a second drive wheel assembly which is arranged in the drive system surface and has a second drive wheel. The latter has a second drive wheel rotation axis, which in turn results as an axis of rotation of the second drive wheel. The second drive wheel is also connected to a drive, preferably an electric motor, for instance a belt drive. With the first and second drive wheel assemblies, the drive system or vehicle can maneuver, for example, flexibly in a storage lane with a small working width; it can be driven differentially. In general words, the drive system can be maneuvered in a narrow space, in particular can be rotated on a spot. The second drive wheel rotation axis preferably lies parallel to the first drive wheel rotation axis, particularly preferably the two axes coincide (reduced wear or reduced interaction between the drive wheels).

In a preferred configuration, the second drive wheel assembly also has a pressing device, wherein, with respect to possible details, reference is made to the preceding disclosure (spring device, damper, etc.). The pressing devices can in particular be structurally identical.

In a preferred configuration, the first support wheel assembly is configured as a rocker which is arranged on the drive system surface. The rocker is preferably suspended substantially centrally, that is to say is connected to the rest of the drive system via a tilting or rocker axis. The tilting or rocker axis preferably lies parallel to the drive system longitudinal axis. On both sides of the suspension point or the tilting/rocker axis, the rocker has in each case one lever arm, wherein in each case at least one omni wheel is arranged on each lever arm. The configuration of the first support wheel assembly as a rocker makes it easier, for example, to ensure permanent contact of at least one or else both omni wheels with the road surface, even if the vehicle crosses over an obstacle, for example.

In a preferred configuration, a main rotation axis of the at least two omni wheels which are arranged on the rocker lies parallel to the first drive wheel rotation axis. This can simplify the crossing over of an obstacle, for example, since the main diameter of the omni wheels drives over said obstacle.

In a preferred embodiment, in the drive system, the first, second and/or third support wheel assembly is equipped with a braking device. The braking device enables the corresponding support wheel assembly to be braked, specifically with respect to the main rotation axis. This can increase, for example, the braking forces which are available.

In a preferred configuration, the first and/or the second drive wheel rotation axis lies orthogonally to the main movement direction of the drive system or of the vehicle. This can facilitate, for example, the maneuvering in a storage lane with a small working width; the vehicle can rotate, for example, on a spot. Furthermore, the main rotation axis(s) of the omni wheel is or are preferably orthogonal to the main movement direction of the vehicle.

The invention also relates to a vehicle having a drive system which is disclosed in the present case, in particular an industrial truck. This can preferably be provided in an autonomously moving manner.

Furthermore, the invention also relates to the use of the drive system in a vehicle, in particular in an industrial truck. This is preferably used in storage lanes of a bay store.

The variant “drive system” can also be combined in the form of the following aspects:
1. Drive system for a vehicle, wherein the drive system comprises:
   a first drive wheel assembly having a first drive wheel;
   a first support wheel assembly having an omni wheel;
   a second support wheel assembly having an omni wheel;
   a third support wheel assembly having an omni wheel;
wherein the first drive wheel has a drive wheel rotation axis which is orthogonal to a drive system longitudinal axis and spans a drive system surface therewith,
wherein the first support wheel assembly is arranged in a first region of the drive system surface which the first drive wheel rotation axis separates from a second region of the drive system surface,
and wherein the second and the third support wheel assembly are arranged in the second region.
2. Drive system according to aspect 1, in which a first support point of the first support wheel assembly, a second support point of the second support wheel assembly and a third support point of the third support wheel assembly are arranged on a polygonal course, wherein an area comprised by the polygonal course makes up at least 30% of the drive system surface.
3. Drive system according to aspect 1 or 2, in which, in each case measured about a drive system vertical axis, a second support point of the second support wheel assembly is spaced apart from the drive system longitudinal axis by a second angular amount and a third support point of the third support wheel assembly is spaced apart from the drive system longitudinal axis by a third angular amount, wherein the second angular amount and the third angular amount differ from one another by at most 20%.
4. Drive system according to one of the preceding aspects, in which, in each case measured about a drive system vertical axis, a second support point of the second support wheel assembly is spaced apart from the drive system longitudinal axis by a second angular amount and a third support point of the third support wheel assembly is spaced apart from the drive system longitudinal axis by a third angular amount, wherein a sum of the second angular amount and the third angular amount makes up at least 20° and at most 120°.
5. Drive system according to one of the preceding aspects, in which a first support point of the first support wheel assembly lies substantially on the drive system longitudinal axis.
6. Drive system according to one of the preceding aspects, in which a first support point of the first support wheel assembly, a second support point of the second support wheel assembly and a third support point of the third support wheel assembly lie on a substantially identical radius with respect to a drive system vertical axis.
7. Drive system according to one of the preceding aspects, in which the first drive wheel assembly comprises a first pressing device, wherein the first pressing device is configured to press the first drive wheel away from the drive system surface onto a road surface.
8. Drive system according to aspect 7, in which the first pressing device comprises at least one of a spring device and a damper device.
9. Drive system according to one of the preceding aspects, comprising a second drive wheel assembly arranged in the drive system surface and having a second drive wheel, wherein the second drive wheel has a second drive wheel rotation axis which is substantially parallel to the first drive wheel rotation axis.
10. Drive system according to one of the preceding aspects, in which the first support wheel assembly is configured as a rocker, wherein at least two omni wheels are arranged on the rocker.
11. Drive system according to aspect 10, in which a main rotation axis of the at least two omni wheel lies parallel to the first drive wheel rotation axis.
12. Drive system according to one of the preceding aspects, in which at least one of the first support wheel assembly, the second support wheel assembly and the third support wheel assembly is equipped with a braking device.
13. Vehicle having a drive system according to one of the preceding aspects.
14. Vehicle according to aspect 13, which is an autonomously moving industrial truck.
15. Use of a drive system according to one of aspects 1 to 12 in a vehicle, in particular in an industrial truck.

### BRIEF DESCRIPTION OF THE DRAWINGS

The invention or the inventions (firstly vehicle combination, then drive system) will be explained in more detail below on the basis of exemplary embodiments, wherein the individual features can also be inventive in other combinations and relate implicitly to all categories of the invention.

In detail:

FIG. 1 shows a perspective view of a vehicle combination according to the invention with a towing vehicle together with a coupling housing in the open state and with an uncoupled trailer,

FIG. 2 shows the vehicle combination according to FIG. 1 in the coupled state,

FIG. 3 shows a sectional detail view of a coupling housing and of a coupling member together with a wheel,

FIG. 4 shows a further embodiment in a representation analogous to FIG. 3,

FIG. 5 shows a further embodiment in a representation analogous to FIG. 3,

FIG. 6 shows a further embodiment in a representation analogous to FIG. 3,

FIG. 7 shows a perspective representation of a towing vehicle with a gripper arm;

FIG. 8 shows a schematic plan view of a drive system for a vehicle, comprising a first drive wheel assembly;

FIG. 9 shows a schematic plan view of a drive system, comprising a first drive wheel assembly and a second drive wheel assembly;

FIG. 10 shows a schematic plan view of a drive system, comprising a first drive wheel assembly and a second drive wheel assembly;

FIG. 11 shows a detailed plan view of the drive system according to FIG. 3, without a representation of the drive wheel assemblies;

FIG. 12 shows a detailed plan view according to a further aspect;

FIG. 13 shows a perspective view of a drive wheel assembly.

### PREFERRED EMBODIMENT OF THE INVENTION

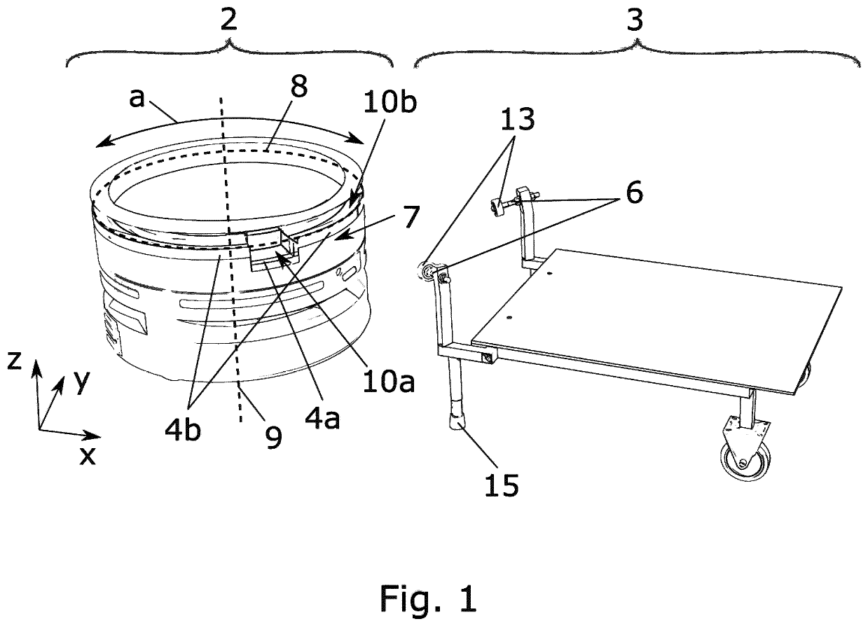

FIG. 1 shows a vehicle combination 1 according to the invention with a towing vehicle 2 and a trailer 3. The towing vehicle 2 is designed to be substantially fully rotationally symmetrical. It is a mobile autonomous robot which can rotate about its vertical axis 9 (rotational movement a) and can move in the horizontal plane x, y. The towing vehicle 2 has a coupling housing 4a, 4b which is in an open state in FIG. 1. For this purpose, a part 4a of the coupling housing is offset vertically downwards relative to the remaining coupling housing 4b. The coupling housing has a total of two such vertically displaceable parts 4a, one of which is arranged on the rear side of the towing vehicle 2 in FIG. 1 and is therefore concealed.

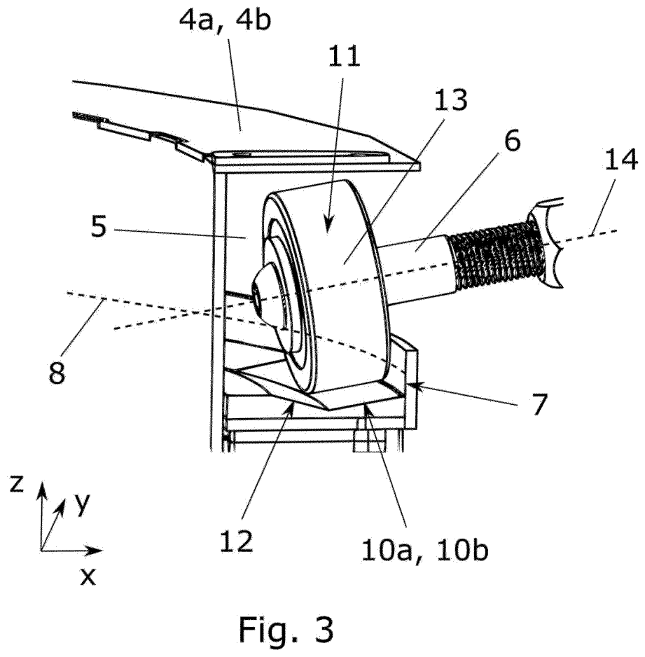

The coupling housing 4a, 4b forms a stop surface 7 (to be seen more clearly in FIGS. 3-6) which extends along an arc line 8. The arc line 8 is in this case a closed, fully rotationally symmetrical curve which completely surrounds the vertical axis 9 (illustrated as a dashed circle). On the right-hand side in FIG. 1, a trailer 3 is illustrated which has two coupling members 6 with in each case one wheel 13. In addition, the trailer 3 has two stands 15 (only one of which can be seen). The stands 15 prevent unintentional rolling away of the trailer 3.

The coupling housing 4a, 4b forms a contact surface 10a, 10b which delimits a cavity 5 of the coupling housing 4a, 4b in the downward direction. In the open state, in which, therefore, parts 4a of the coupling housing are offset vertically downwards, the corresponding parts of the contact surface 10a are also offset downwards relative to the remaining contact surface 10b and are therefore located in a vertical position below the wheels 13 of the coupling members 6. The towing vehicle 2 is therefore ready for coupling; it can receive the coupling members 6 in the vertically offset parts 4a of the coupling housing 4a, 4b and then raise them.

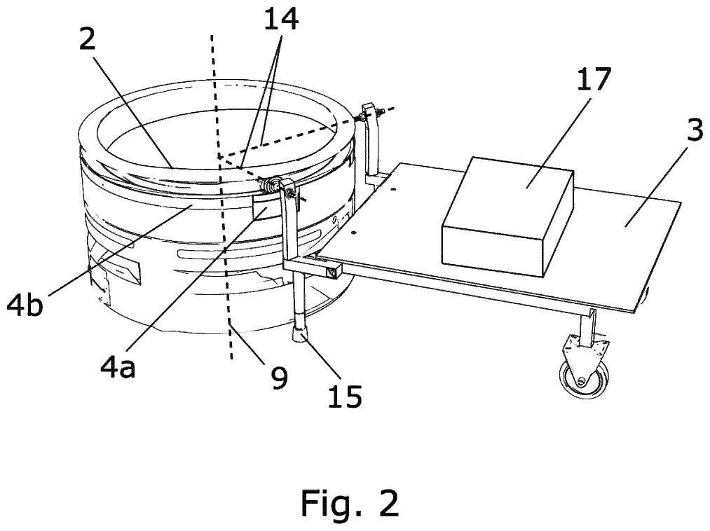

In FIG. 2, the coupling housing 4a, 4b is in the closed state and the trailer 3 is coupled. Since the trailer 3 is in the coupled state, its stands 15 are raised and the trailer 3 is ready for driving, that is to say the load 17 illustrated here by way of example can be transported. Likewise illustrated are axes of rotation 14 of the wheels 13 of the coupling members 6. They intersect at one point with the vertical axis 9 which constitutes an axis of rotation of the towing vehicle 2. This enables a rotation of the towing vehicle 2 about its vertical axis 9 without moving the coupled trailer 3.

FIG. 3 shows a sectional detail view of the coupling housing 4a, 4b and its interaction with the coupling member 6. The coupling housing 4a, 4b forms the cavity 5 into which the wheel 13, mounted on one side, of the coupling member 6 can be inserted.

The cavity 5 is delimited in the horizontal direction x, y by the stop surface 7 which extends along the arc line 8. The cavity 5 is delimited in the downward direction by the contact surface 10a, 10b which forms a support for the wheel 13, that is to say for the tread surface 11 thereof. The contact surface 10a, 10b is of raised design, that is to say is inclined transversely towards the center of the arc line (in the negative x direction in this representation). As a counterpart to the contact surface 10a, 10b, the guide surface 12 is inclined transversely outwards (in the positive x direction). The wheel 13 rotates about the axis of rotation 14 and can move within the closed coupling housing 4a, 4b by it rolling on the contact surface 10a, 10b.

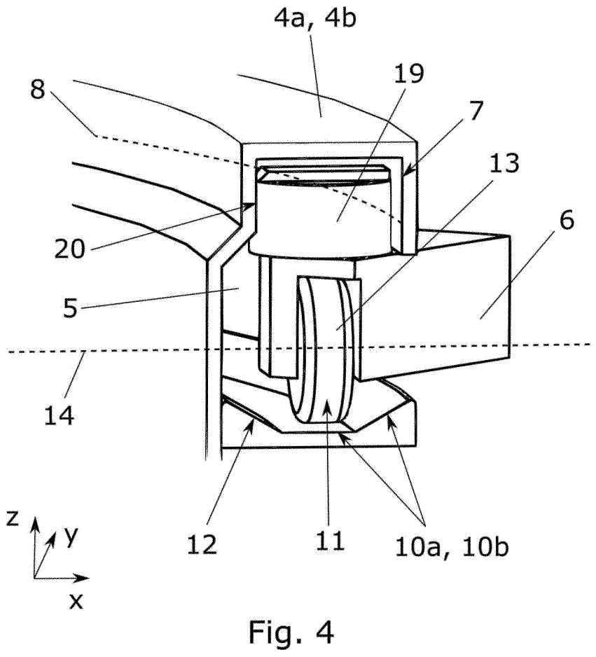

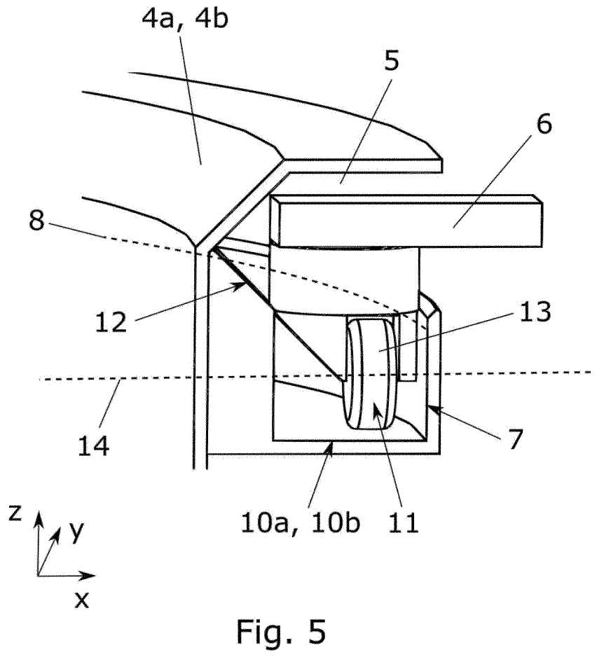

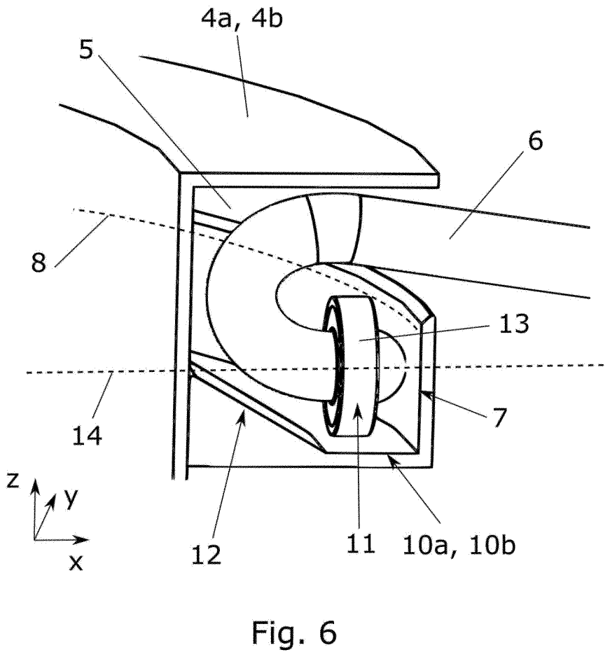

FIG. 4 shows a further embodiment of the coupling housing 4a, 4b and of the coupling member 6 in the same type of representation. In this case, functionally equivalent elements are denoted by the same reference symbols as in FIG. 3 (the same applies to FIGS. 5 and 6). In general, the above description also relates to the following embodiments and the differences are predominantly described.

In this embodiment, the wheel 13 is mounted on both sides and can rotate about the horizontally oriented axis of rotation 14. The contact surface 10a, 10b is divided into an inner, horizontal section and an outer section which is inclined transversely towards the center of the arc line (here in the negative x direction).

The stop surface 7 is arranged in the upper region of the coupling housing 4a, 4b and can (in contrast to the embodiment illustrated in FIG. 3) not come into contact with the wheel 13, but rather with an upper part 19 of the coupling member 6. On the side lying horizontally opposite the stop surface 7, this part 19 of the coupling member 6 can come into contact with an inner surface 20 of the coupling housing 4a, 4b. The coupling member 6 is therefore enclosed in a form-fitting manner in the horizontal on the inside and outside by the coupling housing 4a, 4b.

In this embodiment, the inclined section of the contact surface 10a, 10b and the guide surface 12 serve primarily for introducing the coupling member 6 into the upper region of the coupling housing 4a, 4b during coupling.

FIG. 5 shows a further embodiment in which the contact surface 10a, 10b is not inclined transversely, but rather is oriented horizontally. The horizontal form-fitting of the coupled coupling member 6 takes place via the inclined guide surface 12 and the stop surface 7 arranged in the lower region of the coupling housing 4a, 4b. For easier introduction of the coupling member 6 during the coupling process, the coupling member 6 has, in its lower region, a form slope which can come into contact with the guide surface 12. The wheel 13 is mounted on both sides and has a horizontal axis of rotation 14.

FIG. 6 shows a further embodiment in which the coupling member 6 is of arcuate design, that is to say the wheel 13 is attached to the end of an arcuate rod. At its end, the coupling member 6 has a rounded portion which can come into contact with the stop surface 7 and serves as a stop. The wheel 13 rests with its tread surface 11 on the horizontally oriented contact surface 10a, 10b. The curved form of the coupling member 6 can come into contact with the guide surface 12 inclined transversely outwards during the coupling process.

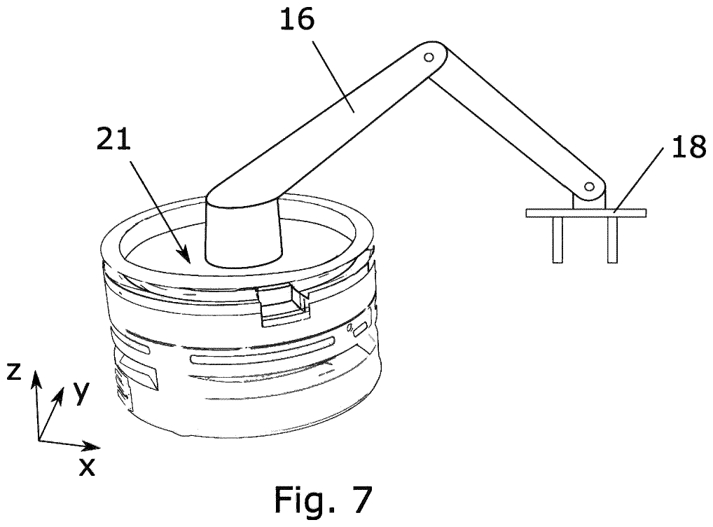

FIG. 7 shows a further embodiment of a towing vehicle 2 with an exemplary gripper arm 16 which is attached centrally on the upper side 21 of the towing vehicle 2. At its end distal from the fastening to the towing vehicle 2, it has a mechanical gripper 18 with which the cargo 17 can be moved and loaded onto the trailer 3.

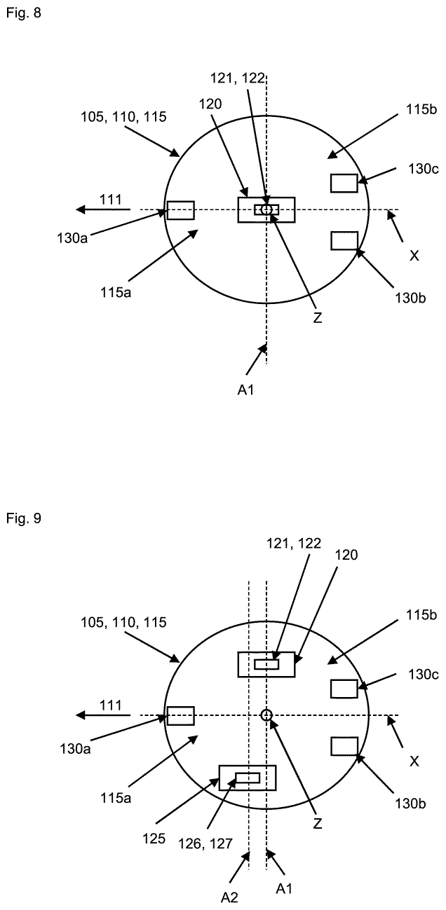

FIG. 8 shows a schematic plan view of a drive system 105 for a vehicle 110. The drive system 105 comprises a first drive wheel assembly 120, a first support wheel assembly 130a, a second support wheel assembly 130b and a third support wheel assembly 130c. The vehicle 110 which is not illustrated in more detail is an industrial truck, for example a mobile robot (see FIG. 7 for illustration), which can be used in storage lanes of bay stores. The drive system 105 has a drive system longitudinal axis X which lies parallel to a main movement direction 111 of the vehicle.

The first drive wheel assembly 120 comprises a first drive wheel 121. The first drive wheel 121 drives the drive system 105. The first drive wheel 321 has a first drive wheel rotation axis A1 which is orthogonal to the drive system longitudinal axis X. The drive system longitudinal axis X and the first drive wheel rotation axis A1 span a drive system surface 315. The drive system 105 furthermore has a drive system vertical axis Z which is orthogonal to the drive system surface 115.

The first drive wheel rotation axis A1 separates a first region 115a of the drive system surface 115 from a second region 115b of the drive system surface 115. The first support wheel assembly 130a is arranged in the first region 115a of the drive system surface 115. The second support wheel assembly 130b and the third support wheel assembly 130c are arranged in the second region 115b. The first support wheel assembly 130a, the second support wheel assembly 130b and the third support wheel assembly 130c each comprise at least one omni wheel 140.

The first drive wheel assembly 120 furthermore comprises a first pressing device 122, see FIG. 6 in detail. The first pressing device 122 is configured to press the first drive wheel 121 perpendicularly away from the drive system surface 115 onto a road surface.

FIG. 9 shows a schematic plan view of a further configuration of the drive system 15. The drive system 5 shown in FIG. 2 corresponds substantially to the drive system 105 shown in FIG. 1. Functionally equivalent elements are described by the same reference symbols as in FIG. 1. The drive system 105 shown in FIG. 2 comprises a second drive wheel assembly 125 arranged in the drive system surface 115. The second drive wheel assembly 125 comprises a second drive wheel 126. The second drive wheel 126 has a second drive wheel rotation axis A2. The second drive wheel rotation axis A2 is substantially parallel to the first drive wheel rotation axis A1. The second drive wheel assembly 125 furthermore comprises a second pressing device 127. The second pressing device 127 is configured to press the second drive wheel 26 perpendicularly away from the drive system surface 115 onto the road surface. By rotating the drive wheels 121, 126 in opposite directions, the drive system 105 can be rotated on the spot, moved forwards by rotating in the same direction.

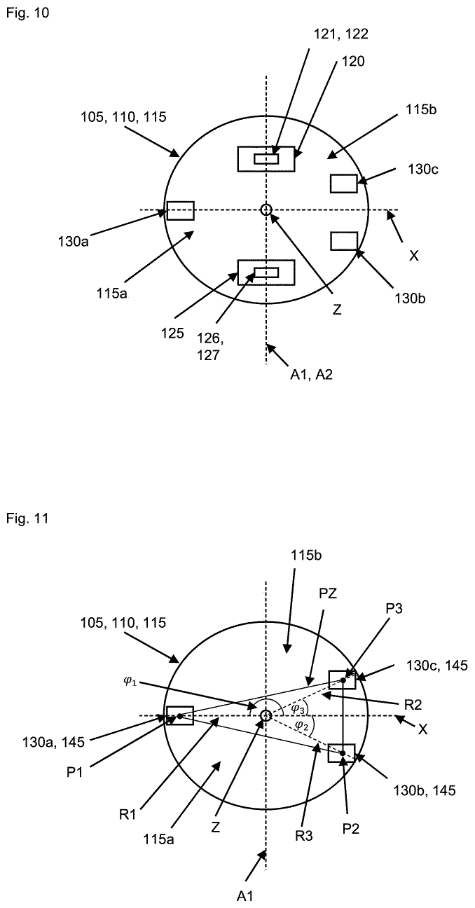

FIG. 10 shows a schematic plan view of a further configuration of the drive system 105. The drive system 105 shown in FIG. 3 corresponds substantially to the drive system 105 shown in FIG. 2. Functionally equivalent elements are described by the same reference symbols as in FIG. 2. The drive system 105 shown in FIG. 3 comprises the second drive wheel assembly 125 arranged in the drive system surface 15, wherein, in the configuration shown in FIG. 3, the second drive wheel rotation axis A2 is substantially identical or congruent to the first drive wheel rotation axis A1.

FIG. 11 shows a detailed plan view of a drive system 105, wherein, for the purpose of simplifying the representation in FIG. 4, the first drive wheel assembly 120 and the second drive wheel assembly 125 are not illustrated. The first support wheel assembly 30a has a first support point P1, the second support wheel assembly 30b has a second support point P2 and the third support wheel assembly 130c has a third support point P3. These support points are arranged on a polygonal course PZ. The polygonal course PZ defines a support polygon of the drive system surface 115.

The first support point P1 of the first support wheel assembly 130a is spaced apart from the drive system longitudinal axis X by a first angular amount |φ₁|, measured about the drive system vertical axis Z. The second support point P2 of the second support wheel assembly 130b is spaced apart from the drive system longitudinal axis X by a second angular amount |φ₂|, measured about the drive system vertical axis Z. The third support point P3 of the third support wheel assembly 30c lies on the drive system longitudinal axis X. The support points P1, P2, P3 lie, measured from the drive system vertical axis Z, on a substantially identical radius R1, R2, R3. At least one of the first support wheel assembly 130a, the second support wheel assembly 130b and the third support wheel assembly 130c is configured with a braking device 145.

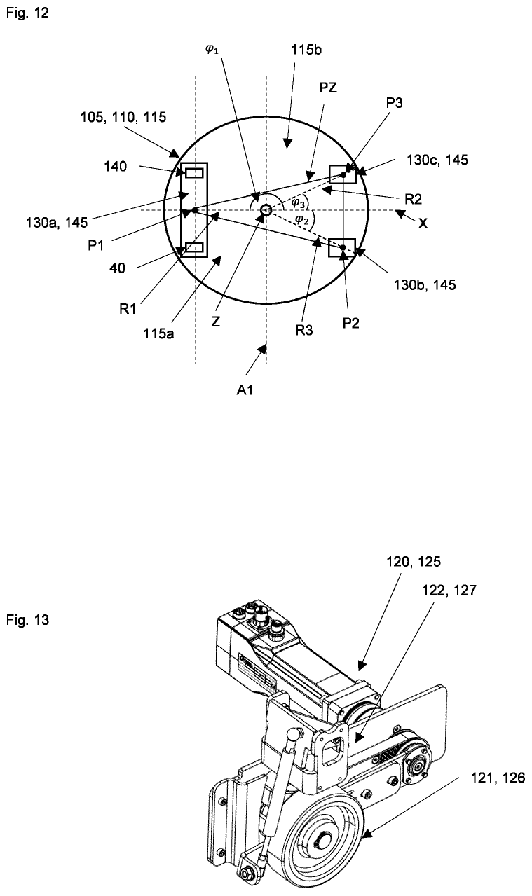

FIG. 12 shows a detailed plan view of the drive system 105 according to a further aspect, again without drive wheel assemblies for the purpose of simplification. In the drive system 105 shown in FIG. 5, the first support wheel assembly 130a is designed as a rocker 135. At least two omni wheels 140 are arranged on the rocker 135. A main rotation axis A3 of the at least two omni wheels 140 extends parallel to the first drive wheel rotation axis A1.

The first support wheel assembly 130a has the first support point P1 which lies at the tilting axis of the rocker, the second support wheel assembly 130b has the second support point P2 and/or the third support wheel assembly 130c has the third support point P3. The first support point P1, the second support point P2 and/or the third support point P3 are arranged on the polygonal course PZ. The polygonal course PZ defines the support polygon of the drive system surface 115.

FIG. 13 shows a perspective view of the drive wheel assembly 120, 125. The drive wheel assembly 120, 125 comprises the drive wheel 121, 126. The drive wheel 121, 126 drives the drive system 105. The drive wheel 121, 126 has the drive wheel rotation axis A1, A2 which is orthogonal to the drive system longitudinal axis X. The drive wheel assembly 120, 125 furthermore comprises the pressing device 122, 127. The pressing device 122, 127 is configured to press the drive wheel 121, 126 perpendicularly away from the drive system surface 115 onto a road surface.

1. A vehicle combination comprising a towing vehicle and a trailer,
wherein the towing vehicle comprises a coupling housing forming a cavity,
and the trailer comprises a coupling member,
wherein the coupling housing can assume an open and a closed state, and wherein the coupling housing forms a stop surface,
which stop surface extends at least in sections along an arc line, and in a section normal to the arc line delimits the cavity in a horizontal direction away from the towing vehicle,
and which arc line is concavely curved with respect to a vertical axis of the towing vehicle and extends over at least half a circulation around the vertical axis of the towing vehicle,
and in which cavity the coupling member can be or is arranged.

2. The vehicle combination according to claim 1, in which the arc line, along which the stop surface extends, is closed in itself circumferentially around the vertical axis.

3. The vehicle combination according to claim 1, in which, at least in the closed state of the coupling housing, the stop surface is at least rotationally symmetrical with respect to the vertical axis of the towing vehicle.

4. The vehicle combination according to claim 1, in which, in the open state of the coupling housing, a part of the coupling housing is offset vertically relative to the remaining coupling housing.

5. The vehicle combination according to claim 4, in which, in the open state, the part of the coupling housing is offset downwards relative to the remaining coupling housing, such that a section, which is formed in the part, of a contact surface which delimits the cavity downwards in the closed state is arranged below a tread surface of the non-coupled coupling member, wherein the tread surface of the coupled coupling member lies on the contact surface within the closed coupling housing, that is to say the coupling member is raised.

6. The vehicle combination according to claim 1, in which the coupling housing forms a contact surface which delimits the cavity downwards and, in a coupled state, that is to say when the coupling member is arranged within the cavity and the coupling housing is in the closed state, constitutes a support for the coupling member, wherein the contact surface is of raised design, that is to say is inclined transversely in the section normal to the arc line towards the curve interior of the arc line.

7. The vehicle combination according to claim 1, in which the coupling housing has a guide surface which, as viewed in the section, is arranged on a side of the cavity which is horizontally opposite the stop surface and slopes away obliquely from the vertical axis.

8. The vehicle combination according to claim 1, in which the coupling member has a wheel which, in a coupled state, that is to say when the coupling member is arranged within the cavity and the coupling housing is in the closed state, is arranged within the coupling housing and lies on a contact surface of the coupling housing which delimits the cavity downwards.

9. The vehicle combination according to claim 8, which has a further coupling member with a further wheel which, in the coupled state, is arranged within the coupling housing and lies on the contact surface, wherein the wheels of the coupling members have axes of rotation which intersect at one point with the axis of rotation of the stop surface.

10. The vehicle combination according to claim 1, in which the towing vehicle has a wheel arrangement or wheel control which is designed such that the towing vehicle can rotate about the vertical axis without horizontal offset.

11. The vehicle combination according to claim 1, in which the towing vehicle is designed to be substantially fully rotationally symmetrical.

12. The vehicle combination according to claim 1, in which the trailer has a stand which is designed to be placed in a frictionally engaged manner in the open state of the coupling housing.

13. The vehicle combination according to claim 1, in which the towing vehicle is designed as an autonomous robot, wherein both its driving movements and the coupling of the towing vehicle to the trailer take place autonomously.

14. The vehicle combination according to claim 1, in which the towing vehicle is equipped with a gripper arm which is designed to load cargo onto the trailer and/or to unload said cargo.

15. A method of using the vehicle combination according to claim 1, in which the trailer is coupled by the coupling member being arranged within the coupling housing and the coupling housing being transferred into the closed state.

16. A drive system for a vehicle, wherein the drive system comprises:
a first drive wheel assembly having a first drive wheel;
a first support wheel assembly having an omni wheel;
a second support wheel assembly having an omni wheel;
a third support wheel assembly having an omni wheel;
wherein the first drive wheel has a drive wheel rotation axis which is orthogonal to a drive system longitudinal axis and spans a drive system surface therewith,
wherein the first support wheel assembly is arranged in a first region of the drive system surface which the first drive wheel rotation axis separates from a second region of the drive system surface,
and wherein the second and the third support wheel assembly are arranged in the second region.

17. The drive system according to claim 16, in which a first support point of the first support wheel assembly, a second support point of the second support wheel assembly and a third support point of the third support wheel assembly are arranged on a polygonal course, wherein an area comprised by the polygonal course makes up at least 30% of the drive system surface.

18. The drive system according to claim 16, in which, in each case measured about a drive system vertical axis, a second support point of the second support wheel assembly is spaced apart from the drive system longitudinal axis by a second angular amount and a third support point of the third support wheel assembly is spaced apart from the drive system longitudinal axis by a third angular amount, wherein a sum of the second angular amount and the third angular amount makes up at least 20° and at most 120°.

19. The drive system according to claim 16, in which a first support point of the first support wheel assembly, a second support point of the second support wheel assembly and a third support point of the third support wheel assembly lie on a substantially identical radius with respect to a drive system vertical axis.

20. The drive system according to claim 16, in which the first support wheel assembly is configured as a rocker, wherein at least two omni wheels are arranged on the rocker.
